(19) United States
(12) Patent Application Publication
(10) Pub. No.: US 2006/0173663 A1
(43) Pub. Date: Aug. 3, 2006

(54) Methods, system, and computer program products for developing and using predictive models for predicting a plurality of medical outcomes, for evaluating intervention strategies, and for simultaneously validating biomarker causality

(75) Inventors: Jason Langheier, Boston, MA (US); Christopher Hans, Columbus, OH (US); Carlos Carvalho, Durham, NC (US); Ralph Snyderman, Chapel Hill, NC (US)

Correspondence Address: JENKINS, WILSON, TAYLOR & HUNT, P. A., 3100 TOWER BLVD, SUITE 1200, DURHAM, NC, 27707, US

(73) Assignee: Proventys, Inc.

(21) Appl. No.: 11/323,460

(22) Filed: Dec. 30, 2005

Related U.S. Application Data
(60) Provisional application No. 60/640,371, filed on Dec. 30, 2004.
(60) Provisional application No. 60/698,743, filed on Jul. 13, 2005.

(51) Int. Cl. G06G 7/48

(52) U.S. Cl. 703/11

(57) ABSTRACT

Methods, systems, and computer program products for developing and using predictive models for predicting medical outcomes and for evaluating intervention strategies, and for simultaneously validating biomarker causality are disclosed. According to one method, clinical data from different sources for a population of individuals is obtained. The clinical data may include different physical and demographic factors regarding the individuals and a plurality of different outcomes for the individuals. Input regarding a search space including models linking different combinations of the factors and at least one of the outcomes is received. In response to receiving the input, a search for models in the search space based on predictive value of the models with regard to the outcome is performed. The identified models are processed to produce a final model linking one of the combinations of factors to the outcome. The final model indicates a likelihood that an individual having the factors in the final model will have the outcome.

### RELATED APPLICATIONS

This application claims the benefit of U.S. Provisional Patent Application Ser. No. 60/640,371, filed Dec. 30, 2004; and U.S. Provisional Patent Application Ser. No. 60/698,743, filed Jul. 13, 2005, the disclosure of each of which is incorporated herein by reference in its entirety.

### TECHNICAL FIELD

The subject matter described herein relates to generating and applying predictive models to medical outcomes. More particularly, the subject matter described herein relates to methods, systems, and computer program products for developing and using predictive models to predict a plurality of medical outcomes and optimal intervention strategies and for simultaneously validating biomarker causality.

### BACKGROUND ART

Predictive models are commonly used to predict medical outcomes. Such models are based on statistical data obtained from populations of individuals that are identified as having or not having a particular medical outcome. Data regarding the population of individuals is typically analyzed to identify factors that predict the outcome. The factors may be combined in a mathematical equation or used to generate a posterior distribution to predict the outcome. In order to predict whether an individual has a particular outcome, the individual may be analyzed to determine the presence of one or more factors (variables). The model may then be applied to the individual to determine a likelihood that the individual will have the particular medical outcome or survival time.

One method by which predictive models are made available to physicians is in medical literature where prediction rules are published. A prediction rule can be an equation or set of equations that combine factors to predict a medical outcome. Physicians can obtain measurements for an individual and manually calculate the likelihood that the individual will have the particular outcome using published prediction rules. In some instances, the scoring of individual predictive models has been automated by making them available via the Internet or in spreadsheets as individual calculators.

One problem with conventional predictive models is that the models are static and do not change based on the identification of new factors. In order for a new predictive model to be generated, statistical studies must be performed, the studies must be subjected to a lengthy peer review and then disseminated to users through publications. There are no standard methods available in the current predictive model generation process of automatically detecting new factors and automatically updating a model based on the new factors.

Another problem with conventional predictive modeling is that predictive models typically only consider the likelihood that a medical outcome will occur or not. Conventional predictive models fail to consider factors, such as the cost or risk of obtaining data required for a particular model, when attempting to score those models to make a prediction. For example, one factor may have a high predictive value with regard to a medical outcome. However, the factor may be extremely expensive or difficult to obtain. Current predictive modeling systems only consider factors associated with prediction of the medical outcome and do not consider cost or difficulty in obtaining or determining whether an individual has a particular factor.

Yet another problem associated with conventional predictive modeling include the inability to validate biomarkers and to update predictive models based on newly validated biomarkers. As described above, new factor identification requires lengthy peer review and dissemination through traditional channels. There is no ability in current predictive modeling systems to rapidly validate new biomarkers and to automatically update predictive models based on newly validated biomarkers.

Still another problem associated with conventional predictive modeling is the inability to simultaneously predict more than a single outcome, including the original medical problem, the efficacy of different treatments and adverse effects of different treatment strategies to resolve that problem. For example, conventional predictive modeling systems typically predict the likelihood that an individual will have a particular outcome, such as a disease. It may be desirable to generate multiple probabilities or likelihoods associated with different outcomes for an individual. In addition, it may be desirable to evaluate different treatment and testing strategies and the effects of these strategies on the likelihoods associated with the different outcomes, and recommend the optimal overall strategy or decision path. Current predictive modeling systems do not provide this flexibility.

Still other problems associated with conventional predictive modeling systems are their inability to integrate with electronic health records (EHRs) or to provide easy to use decision support interfaces for physicians or patients. As stated above, conventional predictive modeling systems include published diagnostic rule sets that physicians are required to apply manually to determine an individual's likelihood of having or developing a particular outcome, or single outcome calculators. Such manual or single outcome systems cannot automatically incorporate EHR data or provide a convenient interface for an individual to view and compare different models and outcomes.

In light of these and other difficulties associated with conventional predictive modeling and model scoring to enable decision support, there exists a need for methods, systems, and computer program products for developing and using predictive models to predict a plurality of medical outcomes and optimal intervention strategies and for simultaneously validating biomarker causality.

### SUMMARY

According to one aspect, the subject matter described herein includes a method for automatically generating a predictive model linking user-selected factors to a user-selected outcome. The method includes obtaining clinical data from a plurality of different sources for a population of individuals. The clinical data may include different physical and demographic factors regarding the individuals and different outcomes for the individuals. Input may be received regarding a search space including models linking different combinations of the factors to at least one of the outcomes. In response to receiving the input, a search for models may be performed in the search space based on the predictive value of the models with regard to the outcome. The models may be processed to produce a final model linking one of the combinations of factors to the outcome. The final model may indicate a likelihood that an individual having the factors in the final model will have the outcome.

According to another aspect of the subject matter described herein, a method for generating a hierarchy of models for screening an individual for a medical outcome may include obtaining clinical data for a population of individuals. Factors associated with the population that are indicative of medical outcome may be identified. Based on the factors, a plurality of predictive models may be generated for predicting the medical outcome. The models may be arranged in a hierarchical manner based on relative predictive value and at least one additional metric associated with applying each model to an individual.

According to yet another aspect, the subject matter described herein includes a system for generating a predictive model linking user-selected factors to a user-selected outcome. The system may include a data collection module for obtaining clinical data from a plurality of different sources for a population of individuals. The clinical data may include a plurality of different physical and demographic factors regarding individuals and different outcomes for the individuals. A user interface module may receive input regarding a search space including models linking different combinations of factors and at least one of the outcomes. A predictive modeler may, in response to the receiving the input, perform a search of the models in the search space based on the predictive value of the models with regard to the outcome. The modeler may process the modules identified in the search and produce a final model linking one of the combinations of factors identified in the search to the selected outcome.
1. According to another aspect, the subject matter described herein includes a system for simultaneously evaluating an individual's risk of a plurality of clinical outcomes. The system includes a predictive modeler for generating models from clinical and molecular data regarding a population of individuals, the models linking predictive factors (predictors) in the population to clinical outcomes. A biomarker causality identification system validates biomarkers. The system may further include a decision support module for receiving input regarding factors possessed by an individual, for receiving input regarding a treatment regimen for the individual, for applying at least one of the models generated by the predictive modeler to the input, and for outputting results indicating the individual's risk of having one of the clinical outcomes given the selected treatment regimen.

The subject matter described herein for developing and using predictive models can be implemented as a computer program product comprising computer executable instructions embodied in a computer readable medium. Exemplary computer readable media suitable for implementing the subject matter described herein include chip memory devices, disk memory devices, programmable logic devices, application specific integrated circuits, and downloadable electrical signals. In addition, a computer program product that implements the subject matter described herein may be located on a single device or computing platform or may be distributed across multiple devices or computing platforms.

### BRIEF DESCRIPTION OF THE DRAWINGS

Preferred embodiments of the subject matter described herein will now be explained with reference to the accompanying drawings of which:

FIG. 1 is a block diagram of a system for developing and using predictive models according to an embodiment of the subject matter described herein;

FIG. 2 is a block diagram of a predictive modeler according to an embodiment of the subject matter described herein;

FIG. 3 is a flow chart illustrating exemplary steps for generating a predictive model according to an embodiment of the subject matter described herein;

FIG. 4 is a group of graphs illustrating the achievement of chain convergence for various predictors of a model after the use of Bayesian Markov Chain Monte Carlo methods according to an embodiment of the subject matter described herein;

FIG. 5 is a flow chart illustrating exemplary steps for generating a hierarchy of predictive models according to an embodiment of the subject matter described herein;

FIG. 6 is a diagram illustrating the application of a hierarchy of predictive models to a population of individuals according to an embodiment of the subject matter described herein;

FIG. 7 is a diagram illustrating generation of a hierarchy of predictive models to a population of individuals according to an embodiment of the subject matter described herein;

FIGS. 8A-8C are graphs illustrating risk scores for a population of individuals to which a hierarchy of predictive models are applied;

FIG. 9A-9F are computer screen shots that may be displayed by a chemotherapy solutions module according to an embodiment of the subject matter described herein; and

FIGS. 10A and 10B are computer screen shots that may be displayed by a coronary surgery solutions module according to an embodiment of the subject matter described herein;

FIG. 11 is a block diagram illustrating biomarker validation according to an embodiment of the subject matter described herein; and

FIG. 12 is a diagram of a decision tree illustrating the use of model output scores to select an optimal treatment regimen according to an embodiment of the subject matter described herein.

### DETAILED DESCRIPTION OF THE INVENTION

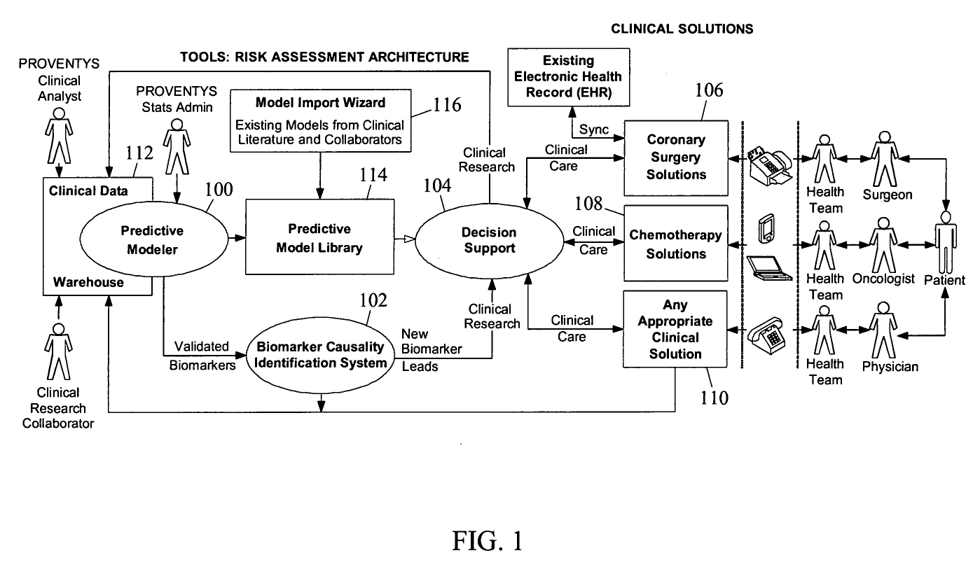

FIG. 1 is a block diagram illustrating an exemplary architecture of a system for developing and using predictive models according to an embodiment of the subject matter described herein. Referring to FIG. 1, the system includes a predictive modeler 100, a biomarker causality identification system 102, and one or more decision support modules 104-110. Predictive modeler 100 may generate predictive models based on clinical data stored in clinical data warehouse 112 and based on new factors identified by biomarker causality identification system 102. The models generated by predictive modeler 100 may be stored in predictive model library 114. Predictive model library 114 may also store models imported by a model import wizard 116. Model import wizard 116 may import existing models from clinical literature and collaborators.

Biomarker causality identification system 102 may automatically extract biomarkers from clinical literature and store that data in clinical data warehouse 112 for use by predictive modeler 100. Decision support modules 104-110 may apply the models generated by predictive modeler 100 to predict clinical or medical outcomes for individuals. In the illustrated example, a coronary surgery solutions module 106 uses a model to predict outcomes relating to coronary surgery. A chemotherapy solutions module 108 predicts outcomes relating to chemotherapy. Decision support modules 104 and 110 are intended to be generic to indicate that the models generated by predictive modeler 100 may be applied to any appropriate clinical or medical solution. Modules 104-110 may be used by surgeons, physicians, and individuals to predict medical outcomes for a patient. Examples of decision support modules will be described in detail below.

In one exemplary implementation, predictive modeler 100 may generate models from clinical and molecular data sequestered in data warehouse 112 regarding a population of individuals, thus linking predictive factors (predictors) in the population to clinical outcomes. In parallel, biomarker causality identification system 102 may validate additional biomarkers measured as part of the data collection process on new patients, that are true predictors even after considering confounding or collinearity with other factors. Newly validated biomarkers can then be used to generate better predictive models and decision support modules. Predictive model library 114 may store predictive models either generated by predictive modeler 100 or imported via model import wizard 116 for manual entry of models from the literature or exported from other applications in Predictive Model Markup Language. Sets of models can be bundled to address a key clinical decision that depends on multiple outcomes and requires stages of testing and screening for optimal cost-effectiveness.

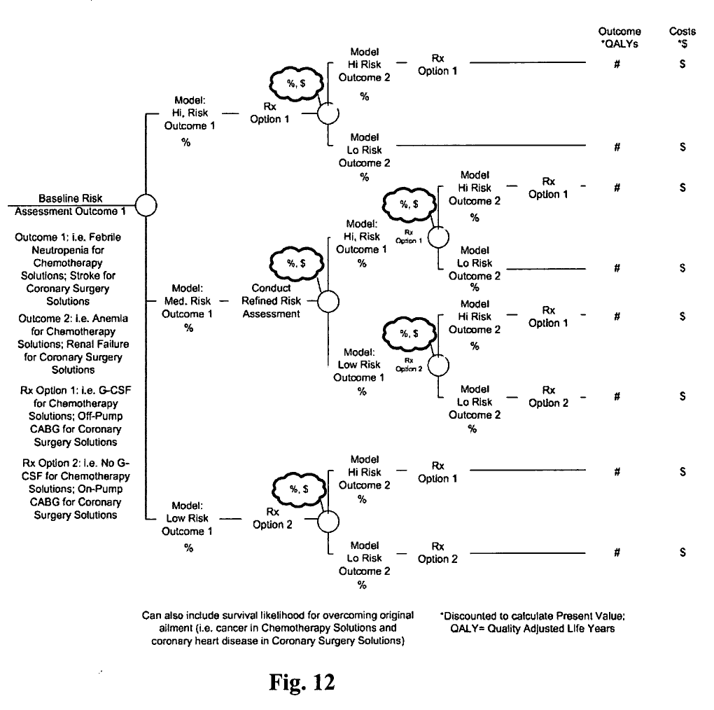

Decision support module, such as one of modules 104-110, as part of a given clinical solution, receives input from an individual and diagnostic team regarding factors possessed by the individual and input regarding potential interventions and applies at least one of the models in predictive model library 114 to the input. The decision support module outputs results indicating the individual's risk of having one of the clinical outcomes, given that individual's factors and the selected intervention strategy. The decision support module automatically constructs a probability and cost-effectiveness decision tree that allows the user to rapidly select either the most beneficial or most cost-effective intervention strategy possible. An example of such a tree will be described in detail below with regard to FIG. 12.

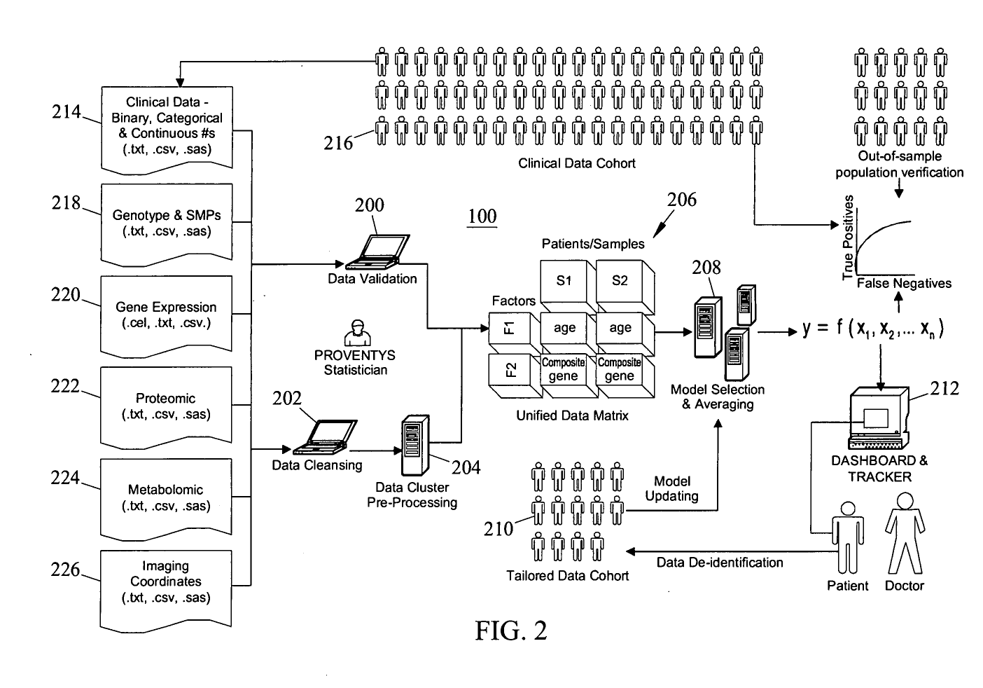

FIG. 2 is a block diagram illustrating exemplary components and data used by predictive modeler 100. Referring to FIG. 2, predictive modeler 100 includes a data validation module 200 for validating clinical data from various sources. A data cleansing module 202 cleanses data from the various sources. A data cluster preprocessing module 204 processes data into a format usable by the predictive modeler. In the illustrated example, the data is formatted into a unified data matrix 206. In the illustrated example, unified data matrix 206 is arranged in rows that correspond to patients or samples and columns that correspond to factors. A model selection and averaging module 208 selects a model from a plurality of models based on user-defined factors, such as predictive value and cost. The result of model selection and averaging is one or more models that can be used to predict a medical outcome for a patient. Model selection and averaging module 208 may also receive data regarding a tailored data cohort 210 and use that data to update one or more models. A dashboard and tracker 212 includes an interface that allows a doctor and/or the patient to access the models and use the models to predict medical outcomes.

In the example illustrated in FIG. 2, predictive model 100 receives clinical data from a plurality of different sources. In the illustrated example, these sources include clinical data 214 from a clinical data cohort 216, genotype and SNPs 218, gene expression data 220, proteomic data 222, metabolic data 224, and imaging or electrophysiology data coordinates 226. These coordinates may come from x-ray mammography, computerized axial tomography, magnetic resonance imagining, electrocardiograms, magnetoencephalography, electroencephalography, and functional magnetic resonance imaging sources.

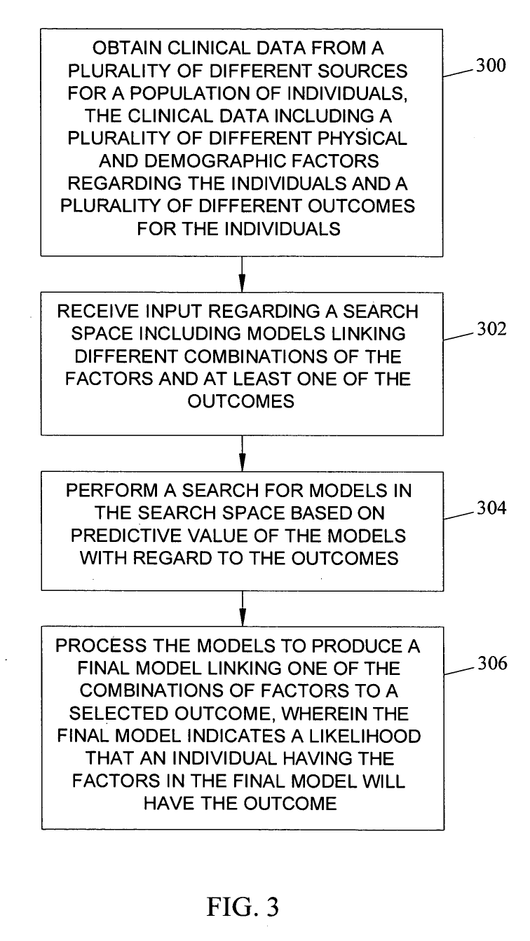

FIG. 3 is a flow chart illustrating exemplary overall steps for automatically generating a predictive model linking user-selected factors to a user-selected outcome. Referring to FIG. 3, in step 300, clinical data is obtained from a plurality of different sources for a population of individuals. The clinical data includes different physical and demographic factors regarding the individuals and a plurality of different outcomes for the individuals. In step 302, user input regarding a search space including models linking different combinations of factors and at least one of the outcomes is received. In step 304, a search for models is performed in the search space based on the predictive value of the models with regard to the outcomes. In step 306, the models are processed to produce a final model linking one of the combinations of factors to a selected outcome. The final model indicates a likelihood that an individual having the factors in the final model will have the outcome.

The outcome predicted by the predictive model may be any suitable outcome relating to an individual, a population of individuals, or a healthcare provider. For example, the outcome may be a disease outcome, an adverse outcome, a clinical trials outcome, or a healthcare-related business outcome. An example of a disease outcome is an indication of whether or not an individual has a particular disease, is likely to develop the disease, and survival time given a treatment regimen. An example of an adverse outcome includes different complications relating to surgery, such a coronary surgery, or medical therapy, such as chemotherapy. An example of a clinical trial outcome includes the effectiveness or adverse reactions associated with taking a new drug. An example of a healthcare-related business outcome is cost of care for an individual.

Once a model or set of models have been generated, the model or set of models may be processed to reduce over-fittings to the population of individuals from which the model or set of models were created. For example, models may be evaluated and revised using factor data collected from individuals outside of the original population. The process of generating the revised model may be similar to that described herein for generating the original model.

As will be described in detail below, the model and the outcomes may be used to provide healthcare-related decision support. For example, decision support module 104 may output a set of potential outcomes associated with a proposed therapeutic regimen and probabilities or risk scores associated with each outcome. The set of potential outcomes may be sorted by disease or therapeutic category. Other outcomes that may be generated by decision support module 104 include outcomes and therapeutic recommendations analyzed for the patient in the past, new outcomes and recommendations, and outcomes not yet analyzed. In addition to using a final model to predict outcomes for an individual, decision support module 104 may generate statistics on risk of an aggregate subpopulation of people versus risk of the complete population for the outcome.

Data Preparation and Upload

Predictive modeler 100 may utilize clinical data that is in non-standardized formats as well as data in standardized formats to generate predictive models. Older datasets stored in databases which lack terminology standards or XML exportation, excel spreadsheets, and paper records must still be reviewed for data quality, consistency and standardized terminology and formatting for incorporation into predictive modeler 100 or any other type of software. However, some datasets contain data with standard terminology according to the Unified Medical Language System (UMLS) inclusive of SNOMED, and transmission of secure encrypted data in Predictive Model Markup Language (PMML; based on XML), and in Extensible Markup Language (XML). Tagging of transported data in this manner allows for the automation recalculating models based on new factors (i.e. if blood sample from the patient cohort are then analyzed for SNPs) or new patient data (10 new patients enter the cohort over the timeframe of 2005 to 2010).

In the original setup of a predictive model project, the lead statistics system administrator or clinical researcher can choose factors and patient criteria to be selected in the ongoing dynamic modeling, and database queries will be automatically generated to extract this information from datasets 214-226. This user can choose if he/she wants to include patients who have missing data for certain factors in data analysis matrices 206, or not.

For statistical analysis using predictive modeler 100, data will be transformed and re-organized into a standard framework. The prepared input is a text file containing “n” rows and “p” columns, where n is the number of patients and p is the total number of variables is the dataset. In the process, variables are relabeled, turned into numerical values (for example gender is recoded as 0/1 instead of Male/Female) and data transformations (such taking the natural log of continuous variables such as age) are implemented where prudent. Both continuous and discrete datasets will be analyzed within this standardized data matrix.

Data Pre-Processing (Gene Expression Data Example)

For the possible addition of gene-expression data, Affymetrix microarray description file will be uploaded into predictive modeler 100. Using .cel files and chip-specific information as inputs, predictive modeler 100 uses tools available in the R (http://www.r-project.org/) package bioconductor (http://www.bioconductor.org/) to convert the data into RMA or MAS 5.0 expression levels (numerical scale). The data is then transformed to the log base 2 scale followed by a quantile normalization. Genes with low levels of expression and low level of variation are filtered out of the dataset. At this point, the gene expression data is laid out in a “p” by “n” matrix (genes by patients).

Still as part of the gene expression data pre-processing, a dimensionality reduction step in implemented. Genomic factors are created by linear combinations of genes. First, genes are clustered (k-means clustering) into “k” (k<p) groups. From each cluster the first principal component is extracted (PCA), summarizing the most important features of the genetic activity in that group. The first principal component is the linear combination with maximum variation. The principal components are obtained by the singular value decomposition of the matrix of expression levels where,
X=ADF
X is the matrix with dimensions p by n. F is the matrix with the principal components of X. In the end, a matrix “k” by “n” (gene factors by patients) is created. Data from this matrix is joined with other factors “f” which have already been pre-processed, or required no data reduction steps. Models are developed from the final matrix “f” by “n” as described below, which may or may not include composite gene-expression factors among “k”. In one exemplary model for adenocarcinoma survival time, composite gene-expression factors 350, 59 and 44 were included as key factors in the fitted model. Each composite gene-expression factor is representative of approximately 5 genes which can be named by linking their Affymetrix, Agilent or other probe identification number to standard databases on gene and protein names.
Missing Data Preparation

Standard methods may be used for imputation of missing values. For example, a complete case analysis could be conducted, in which subjects with missing values for particular variables are deleted from the analysis. Alternatively, the mean value of all the other subject's values for a given predictor, could be inserted for the missing values for that variable; rather than the mean, the predicted value based on using the other values could be used. For categorical variables (including binary factors), the missing values can be considered as an additional category (i.e. male, female, missing). The strengths and weaknesses of these various approaches have been discussed previously.

Time Series Pre-Processing

Standard summary methods may be used for time-series pre-processing of data. For example, the average value across all outcomes track longitudinally can be used. Alternatively, a mixed model could be used according to the methods described previously for longitudinal data analysis.

Model Search

The space of possible models linking a well-defined adverse outcome to the variables available in the dataset will be explored. The goal is to find models with high predictive power. Two different techniques will be used at this step, each paired with two different selection criteria. In one exemplary implementation, for a small enough number of possible predictive variables (up to 15), enumeration is used to compare all the 2^{P} possible models. Predictive modeler 100 lists all possible models and computes the predictive score for each one of them. When the number of explanatory variables increases, enumerating all possible models is not feasible and search methods are required.

In large dimensional problems (large number of possible predictors) predictive modeler 100 executes a stepwise approach that searches the model space in a forward/backward manner. Starting from the null model (model with no predictive variable), each step compares the predictive score of all models generated by adding a variable and by deleting one. For example, if there are 300 variables in the dataset and the current model has 3 predictors, the next step will choose amongst the 297 possible models with one more variable and the 3 models with one less variable. The search moves to the best model in that set. By repeating this procedure a number of times, a large set of models is compared. This is a deterministic, greedy search, where in every step the algorithm moves to the best possible option. Alternative stochastic search methods are also available. In this case, in every step, a set of neighboring models is computed and the move is decided randomly with probabilities proportional to the predictive score of each visited model. All the search methods here described can be implemented in parallel, with different starting points, improving the exploration of the model space.

In the end, predictive modeler 100 outputs a list of models and the respective predictive scores. The top models will be later compared on the basis of out-of-sample prediction, cost-effectiveness, specificity/selectivity, etc.
Selection Criteria/Predictive Score assessment: Two selection criteria are available in the model search methods described above:

Akaike Information Criteria (AIC) and Bayesian Information Criteria (BIC). Both criteria are computed as:

$$Score = - 2 {\sum }_{i = 1}^{N} log ( p ( {y}_{i} \text{\vert} θ ) ) + Kp$$

That is minus two times the log-likelihood of the model for all N observations plus K times the number of parameters in the model (size of the parameter vector theta).
In the AIC option the penalty K equals 2, and in the BIC it equals log (n).

BIC imposes a higher penalty in dimension therefore selecting more parsimonious models than the AIC option. Alternative penalties can be used by predictive modeler 100 without departing from the scope of the subject matter described herein.

Model Fitting

Bayesian estimation of the models selected in the previously described steps is performed. By using standard non-informative priors for the parameters, Markov Chain Monte Carlo (MCMC) methods are implemented to explore the posterior distribution of parameters in the models. Samples from the joint posterior distribution of parameters summarize all the available inferential information needed to create point estimates and confidence intervals. For time to event outcomes (survival models) the data is modeled using a Weibull survival model with the following specification:

$$\begin{matrix}f ( y \text{\vert} α , λ ) = α {y}^{α - 1} exp ( λ - exp ( λ ) {y}^{α} ) \\ λ = {\sum }_{i = 1}^{p} {β}_{i} {X}_{i}\end{matrix}$$

Y is the time to event, alpha, lambda and betas are the parameters.

In the case of disease status (binary outcome) logit models are used with following specification:

$$\begin{matrix}p ( y \vert θ ) = {θ}^{y} {( 1 - θ )}^{( 1 - y )} \\ log ( \frac{θ}{1 - θ} ) = {\sum }_{i = 1}^{p} {β}_{i} {X}_{i}\end{matrix}$$

Here Y is a 0/1 disease status and thetas and betas are the model's parameters.

An example outcome is a model which includes the following factors:

Composite gene factor 350, composite gene factor 44, composite gene factor 59, T (tumor size), N (number of lymph nodes with tumors) and K-ras (tumor cells positive for K-ras protein according to immunohistochemistry staining).

Data Quality Checks

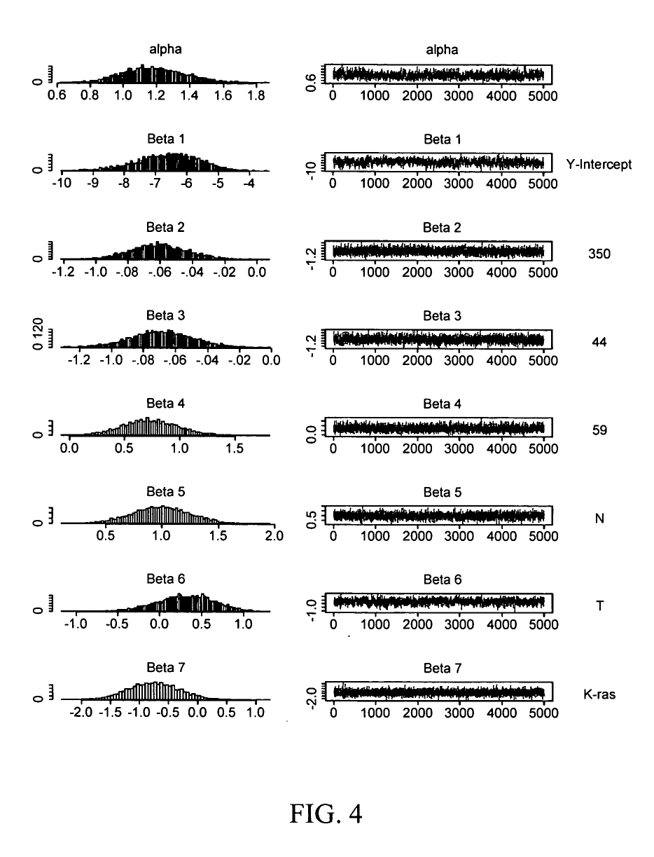

Numerous data checks may be employed to assess missing data, data distributions, and quality of model fit. An example of the latter is chain convergence, as shown relative to the predictive factors in the top predictive model. Chain convergence assesses whether or not the estimation of the parameters of a model are appropriate, using Bayesian MCMC methods. The graphs in FIG. 4 illustrate distribution of the parameter estimates (left), and whether or not the model fitting step has converged appropriately (right).

Predictive Accuracy

Leave-one-out cross-validation, testing and training sets and bootstrapping are used to check the predictive performance of each of the selected models. In each step one or parts of the sample are held out of the estimation and are predicted after the model is fitted. The predictive algorithm can then be evaluated by generating a Receiver Operating Curve and by calculating the concordance index (c-index). The highest sensitivity (low false negatives) and highest specificity (high true positives) predictive models possible are identified.

Model Management

Model Results Storage
Output of bootstrap, leave one cross validation and model training in PMML or standard XML
Linkage of Input Data with Models Generated table linked by database key
   Models table includes data on predictive accuracy (c-index, sensitivity, specificity figures), aggregate factor cost, aggregate factor risk of procurement score, and other metrics.

Ranking and Sorting
Primary ranking by predictive accuracy (c-statistic)
Secondary ranking of values using factor characteristics such as cost, risk of procurement (risk of the diagnostic test), and others.
   Features of Predictive Modeler 100

Predictive modeler 100 may automate processing of clinical data as an ongoing assembly line and dynamically update predictive models with a focus on optimizing predictions. Some of the components of setting up such a “factory line” of data analysis for the creation of predictive models have been carefully researched, such as gene-expression analysis, various model search and selection methods, Bayesian model fitting parameters, the validity and usefulness of model averaging, yet, no solution is available which:
Automatically produces models for decision support tools that can predict timing (when time data is available) and probability of an event with confidence intervals to represent uncertainty in a quantitative yet interpretable way
Automates the integration of heterogeneous data sets which require different pre-processing steps, into a factor data matrix for automated model search, such as
   Demographic information (age, gender)
   Simple lab tests (i.e. cholesterol)
   Traditional clinical diagnoses and medical history (i.e. physician radiology interpretations, Dx of diabetes, etc.)
   SNP genotyping data (categorical demarcations of dominant-dominant, dominant-recessive, recessive-recessive and specific SNP subtypes)
   Genotype number of subunit repeats for rare subunit repeat disorders (i.e. Huntington's Disease); such tools will used when preventive treatments become available for such disorders
   Gene-expression, proteomic (including antibodies and cytokines) or metabolomic data
      High-volume molecular datasets such as Affymetrix microarray data are prepared using the MAS 5.0 method, log base 2 transformation and quantile normalization, followed by the removal of low expressing and non-varying genes. Data reduction to allow for effective model searching is achieved through k-means clustering followed by principal component analysis (PCA). These composite factors are then compared alongside other potential predictors of a given outcome as part of model development.
   Mass spectrometry fingerprinting and protein data by automated peak identification, comparison with known protein libraries and clustering and principal component analysis of such proteins
   Electrocardiogram (EKG) data, where automatic detection of EKG characteristics like ST-segment elevation (STE), ST-segment depression (STD), pathological Q-waves (PQW), and T-wave inversion and their frequency are summarized and scored for use as predictive factors (most often for cardiac conditions such as angina)
   Magnetoencephalography (MEG), electroencephalography (EEG) and functional magnetic resonance imaging (fMRI) data points which can be summarized and scored for use as predictive factors (most commonly for brain conditions such as epilepsy)
   Anatomical imaging information such as echocardiography, MRI, CAT scans, mammography and X-ray can also be represented by points on a numerical grid, and the size and frequency of aberrations (i.e. calcification spots detected by mammography in breast) can be used as predictive factors.
   Time series information (i.e. daily glucose readings or short-term ongoing measurement of creatine kinase-MB, Troponin I, Troponin T and other cardiac markers post-myocardial infarction, or time series of any of the above types of data collected at multiple time points) in the model search methods)
   Environmental data correlating patient home, work and other common locations to various environmental risk factors house in open source datasets and other registries that have geocoded such factors using Global Information Systems (i.e. lead levels in your home and work geography).
Automates search and selection process using integrated data and uploaded outcomes and to find highest accuracy models while avoiding overfitting by comparison with automatic out-of-sample datasets (when data available).
Enables use of multiple model search techniques (stepwise, variable-limited enumeration, stochastic searches using parallel computing) and selection criteria (Akaike Information Criteria or Bayesian Information Criteria) which can all be run simultaneously, but all with the ultimate goal of finding the most accurate predictive models. Bayesian Weibull model fitting approaches are used when time to adverse outcome is known, and cross-validation generates predictions to assess predictive accuracy (area under the receiver operating curve), sensitivity and specificity.
Multiple sorting of models using not only predictive accuracy, but also uploaded factor information, such as cost and risks of the factor tests on individuals, when conducted in various settings; this allows for the automated selection of models which meet a certain Proventys standard threshold of high accuracy while minimizing cost to insurers, physicians and patients, and minimizing risk to patients undergoing diagnostics.
Automatic benchmarking of predictive accuracy using out-of-sample populations to assess effectiveness within the broader population and specific patient sub-groups (when data available)
Creation of Decision Tree which split groups of patients by differences one factor at a time, using Bayesian filling methods; such Decision Trees can be dynamically implemented by physicians or patients themselves, using decision support module 104 to ask questions about outcome probabilities based on various new types of new information entered into the system
Automatically incorporates new patient information tagged with standard XML field names, or PMML data, without manual pre-screening
Dynamically incorporates new data to increase sample size on an ongoing and real-time basis in order to improve model quality and validate accuracy in new populations and subgroups
Uses standardized transmission standards using PMML and XML to facilitate communication to other software packages and to regulatory agencies such as the FDA
Displays a “dashboard” for a statistician system administrator to review automatically generated quality control checkpoints on a large set of new patient data and new models created on a real-time and ongoing basis, for multiple models, multiple diseases and multiple sites. The dashboard facilitates the statistics system administrator's role as the final quality control checkpoint before the employment of improved models or transmission to regulatory authorities in a standardized format, on an ongoing basis.
Predictive modeling links to and powers a Decision Support system, which includes the following outputs:
   A set of outcomes being analyzed and predicted for the patient
      List shows outcomes which have been analyzed in the past, new outcomes analyzed this time, and outcome not analyzed; organized by disease and therapeutic categories
   The date of each outcome calculation, and factor data that went into each calculation and their dates taken (date sample taken-such as blood, and date sample analyzed)
   Probability of event (the outcome) occurring with a confidence interval and within a fixed time period
   Timing of the event with confidence interval for a fixed probability of occurrence
   Graphs comparing patient to the risk probabilities of the rest of the population and subcategories of the population (such as by race, gender, etc.) in the US and/or that local geography and/or that health system and/or that medical center and/or that clinic and/or within the patient panel of that physician or health team.
   Personalized health plan
      Graphs showing how much risk can be mitigated (probability of adverse outcome can be decreased and time to event can be lengthened) by the alteration of various factors included in the model and displayed, which the patient can work to change (such as direct behavioral factors—i.e. smoking or not smoking, or indirect lab values such as LDL cholesterol).
      Therapeutic recommendations for physicians to deliver to patients
      Therapeutic recommendations directly for patients
      Display of target risk, target timing, and methods to improve or alter negative factors so that they no longer contribute significantly to adverse event probability; also praise for maintenance of positive factors
      Display of all of the above types of information over time. For factors which are collected with different frequencies (such as blood sugar monthly based on averaged daily values, but cholesterol yearly), retain most recent of any factor and re-calculate; delivers praise for improvements in risk scores.
      Patient Education—Description of potential etiology of predicted events, as well as diagnosed illnesses and display using text and mapping using the visual human anatomy projects funded by NIH.
      Ability to display via the Internet using an ASP; patients may enter new data via the web using online questionnaires, scannable paper scorecards and surveys or the telephone and may view updated personalized health plan and health tracking (data over time) via the web on a computer, PDA, mobile phone or other web-enabled device.
   Summary reporting
      Summary statistics on risk of aggregate patient panel vs. risk of population and various subpopulations, for various outcomes.
      Updated model parameters and clinical factors after the addition of new patients on a particular day; highlighting of new factors as potential contributors to disease physiology or health protection
      Review of patient panel displaying which fall into low, medium or high-risk categories for various outcomes, and the last and next appointment, current personalized health plan recommendations and therapeutics and diagnostic monitoring regimen of each patient. High risk patients which have not been seen or without proper intervention are flagged for further review.
         Predictive modeler 100 and/or decision support module 104 may perform any one or of the above-listed functions.
         Generating a Hierarchy of Models for Predicting a Medical Outcome

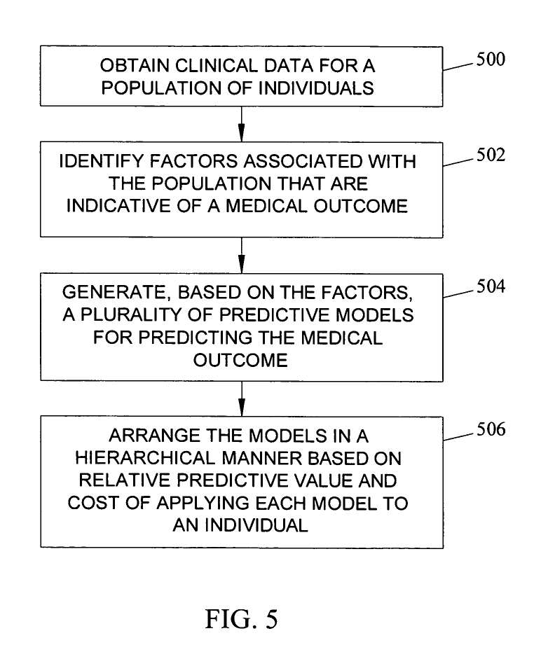

As described above in the Summary section, one aspect of the subject matter described herein includes generating a hierarchy of models for predicting a medical outcome. FIG. 5 is a flow chart illustrating exemplary steps that may be used by predictive modeler 100 for generating a hierarchy of models for predicting a medical outcome. Referring to FIG. 5, in step 500, clinical data is obtained for a population of individuals. In step 502, factors associated with the population that are indicative of the outcome are identified. In step 504, a plurality of predictive models is generated based on the medical outcome. In step 506, the models are arranged in a hierarchical manner based on relative predictive value and at least one additional metric associated with applying each model to an individual. The additional metric may be monetary cost to the individual or to an organization of determining whether the individual possesses a particular factor. In another example, the additional metric may be risk to the individual associated with performing a test to determine whether or not the individual possesses the factor. The additional metric may be any suitable factor other than predictive value for arranging and applying predictive models in a hierarchical manner.

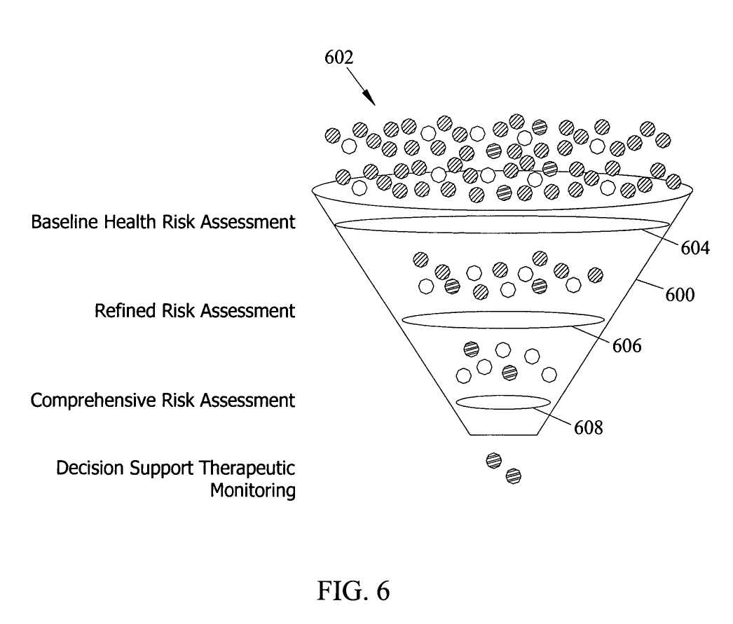

FIG. 6 is a diagram illustrating exemplary uses of a model hierarchy in clinical risks scoring. In FIG. 6, cone 600 represents a hierarchy of predictive models that may be generated by predictive modeler 100. Circle 602 represent individuals that are of high, intermediate, and low risk of having a particular outcome. The first level 604 in the hierarchy represents a baseline health risk assessment. Predictive modeler 100 may generate a model for this level that has low predictive value and that is based on factors that are relatively inexpensive or low risk to obtain. The result of applying the baseline health risk assessment is a narrowing of the population of individuals that pass to the next level. Level 606 represents a redefined risk assessment which has slightly more predictive value than the baseline risk assessment and slightly increased cost or risk associated with obtaining the factors. The result of applying the model at level 606 is a smaller subset of the population to which a comprehensive risk assessment should be performed. Level 608 represents a comprehensive risk assessment that contains factors with the highest predictive value, but also the highest cost and/or risk in obtaining the factors. The result of applying the comprehensive risk assessment 608, is the identification of high risk individuals in the population.

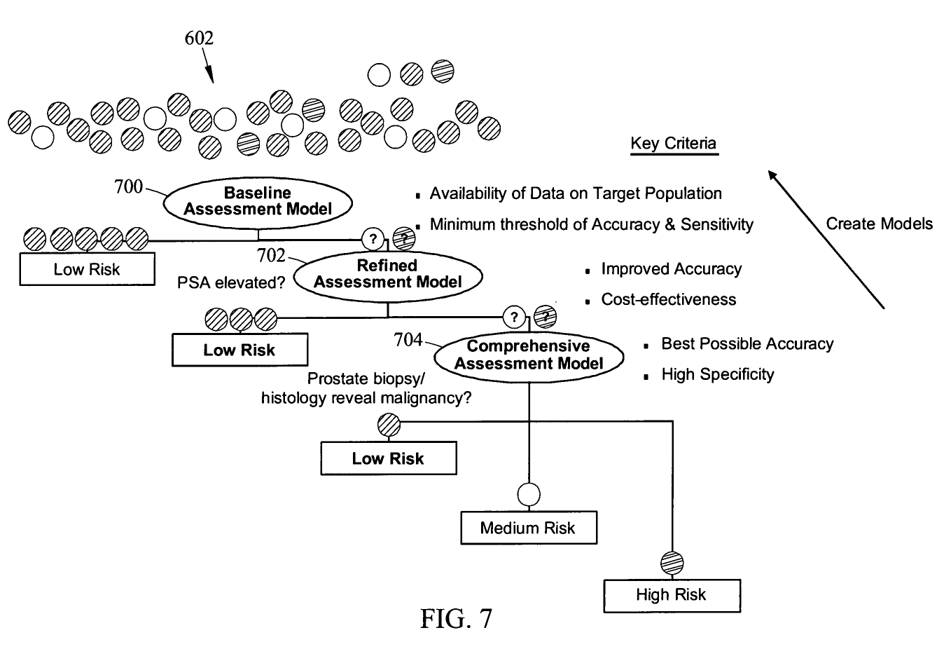

FIG. 7 is a diagram illustrating an example of the use of a plurality of models for hierarchical screening for identifying individuals with prostate cancer. Again, in FIG. 6, circle 602 represent the population of individuals. The hierarchy of models are shown in a decision tree format in FIG. 7. More particularly, oval 700 represents the baseline risk assessment model, oval 702 represents the refined risk assessment model, and oval 704 represents the comprehensive risk assessment model. As with the example illustrated in FIG. 6, as lower levels of the hierarchy are reached, models increase in predictive value and cost.

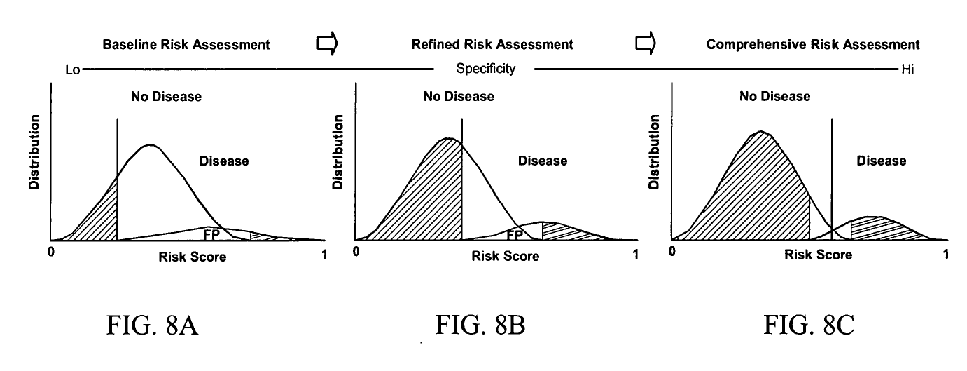

FIGS. 8A-8C illustrate the differences in specificity between the baseline risk assessment models, refined risk assessment model, and comprehensive risk assessment models illustrated in FIGS. 6 and 7. More particularly, FIG. 8A illustrates the distribution of risk scores for the population based on the baseline risk assessment, FIG. 8B illustrates the distribution of risk scores for the redefined risk assessment, and FIG. 8C illustrates the distribution of risk scores for the comprehensive risk assessment.

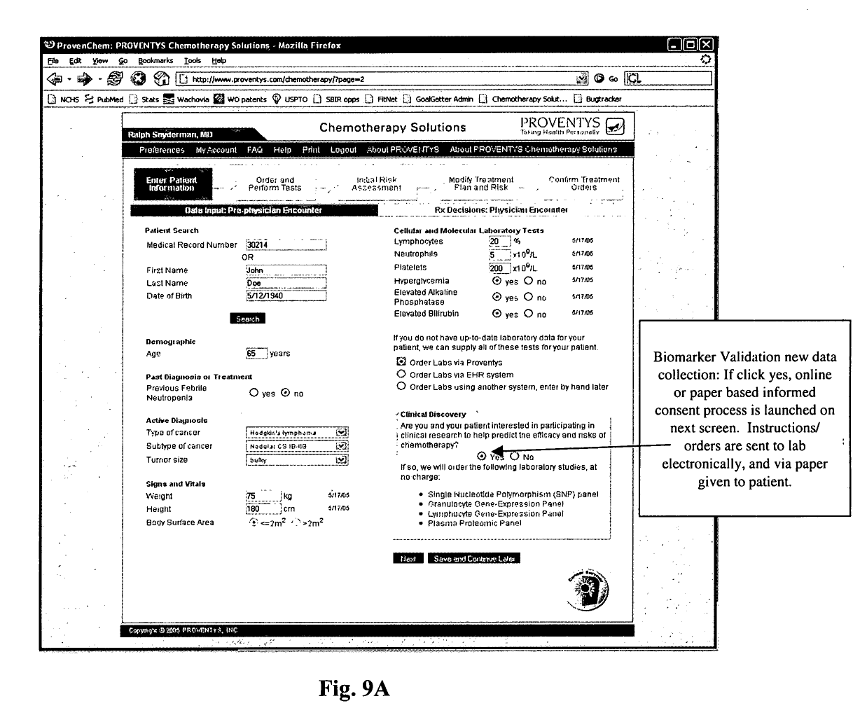

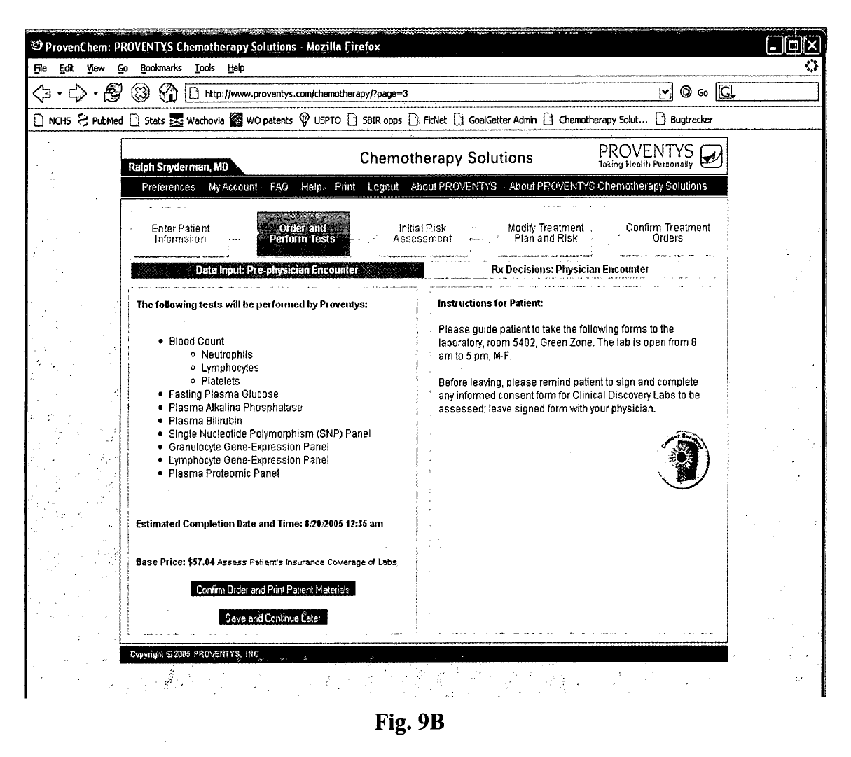

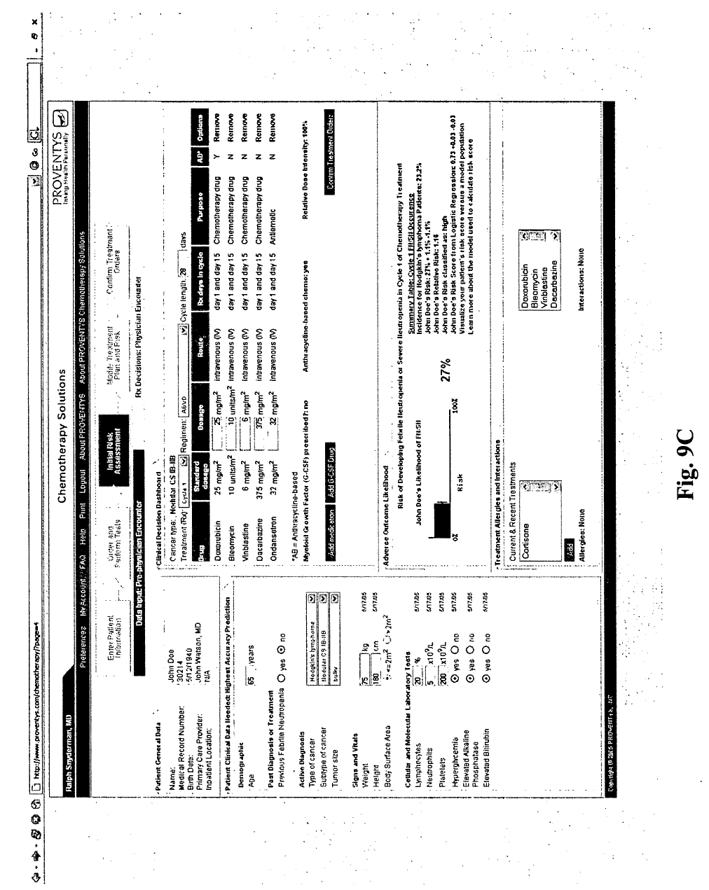

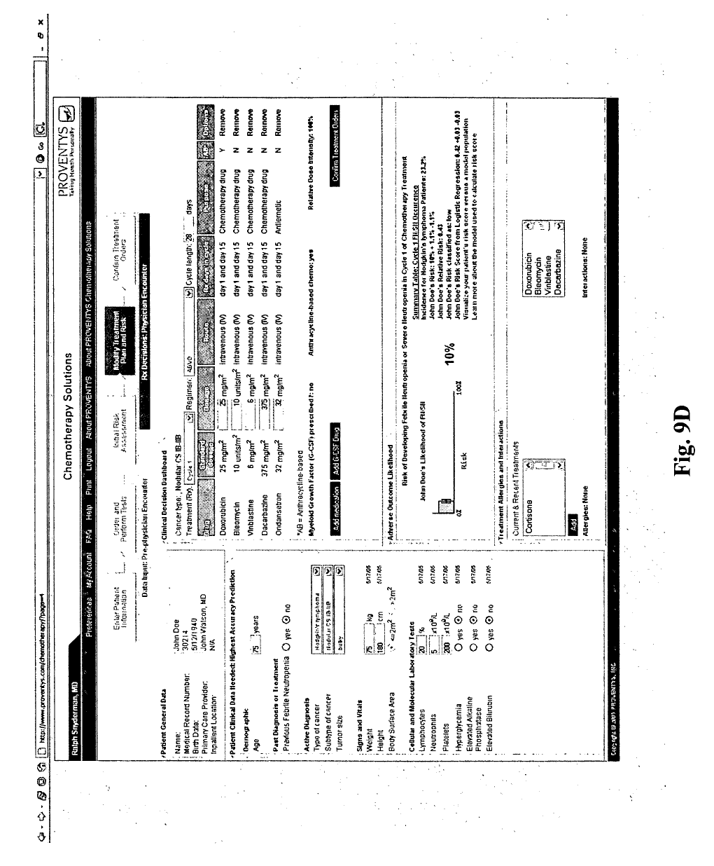

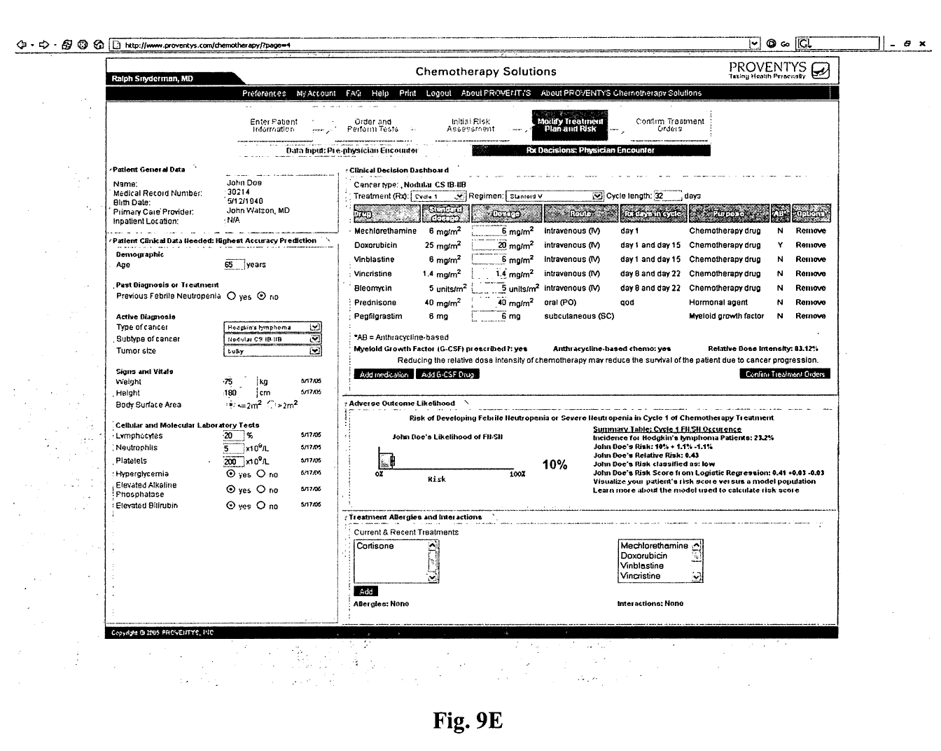

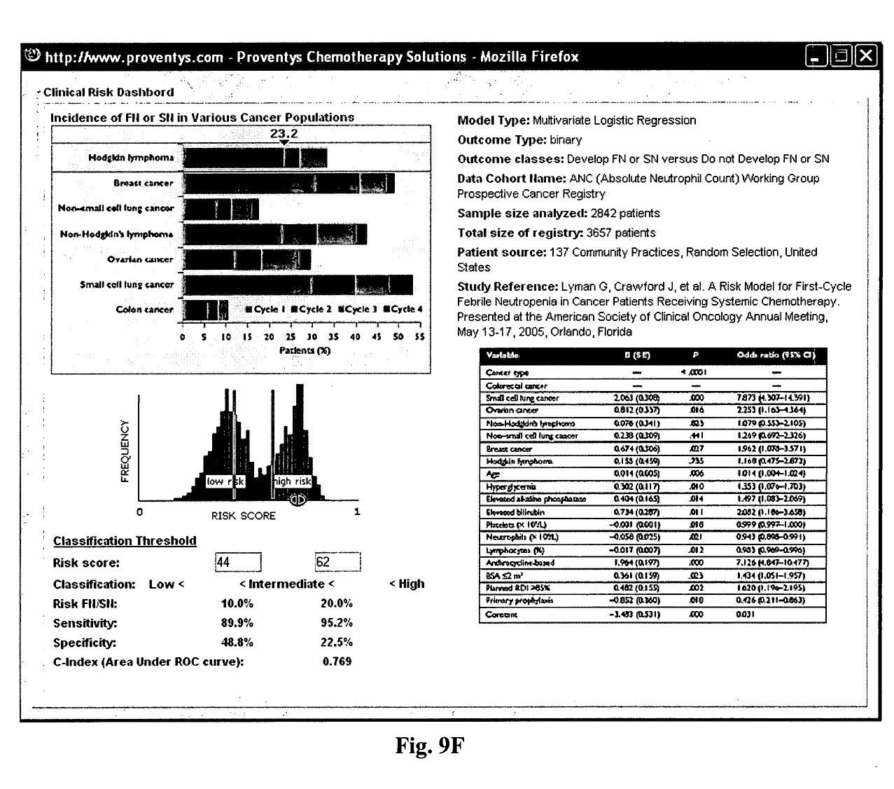

As stated above, the system illustrated in FIG. 1 may include decision support modules that apply predictive models, generate multiple outcomes, and that evaluate the efficacy of different treatment options on the outcomes. FIGS. 9A-9F are computer screen shots of exemplary user interfaces and functionality that may be provided by a decision support module according to an embodiment of the subject matter described herein. Referring to FIG. 9A, a computer screen shot of a patent information screen for chemotherapy solutions module 108 is presented. The purpose of the chemotherapy solutions module is to evaluate and present outcomes associated with particular chemotherapy regimens. In FIG. 9A age, demographic information, and lab test information is obtained for an individual. The individual is also prompted as to whether the individual is willing to participate in clinical research to assist in new biomarker validation. If the individual selects “Yes,” then the individual will be presented with the appropriate consent forms for participating in biomarker validation and the appropriate orders will be sent to the lab that will conduct the tests required for biomarker validation.

In response to receiving a click on the “Next” button from the data entry screen of FIG. 9A, chemotherapy solutions module 108 may present the user with an order and perform tests screen, as illustrated in FIG. 9B. In FIG. 9B, the order and confirm test screen includes the lab tests ordered in FIG. 9A and instructions for the patient. When the user clicks “Confirm Order and Print Patient Materials,” chemotherapy solutions module 108 orders the selected tests from a lab.

The next screen that may be presented by chemotherapy solutions module 108 is the initial risk assessment screen, as illustrated in FIG. 9B. In FIG. 9B, the initial risk assessment screen displays lab data for the individual. In addition, the risk assessment screen includes a clinical decisions dashboard that indicates the individual's risk of developing febrile neutropenia as a result of a chemotherapy regimen. The dashboard displays the drugs involved in the chemotherapy regimen and the dosage amounts of each drug. The drugs and dosage amounts are modifiable by the user. If the user modifies the drugs or the dosage amounts, chemotherapy solutions module 108 will automatically recalculate the individual's risk of developing febrile neutropenia. In addition, the dashboard allows the user to modify treatment orders or add a G-CSF drug. In response to either of these actions, chemotherapy solutions module 108 will recalculate the individual's risk of febrile neutropenia. Thus, the dashboard illustrated in FIG. 9B provides a convenient method for a physician or a patient to evaluate different outcomes and treatment options.

FIG. 9C illustrates an exemplary modify treatment plan screen that may be displayed by chemotherapy solutions module 108 if the user modifies any of the medications illustrated in FIG. 9C. In FIG. 9C, it can be seen that the individual's risk of febrile neutropenia has decreased from 27% to 10% as a result in changes of dosage amounts of some of the drugs displayed by the dashboard.

FIG. 9D illustrates another example of a modify treatment plan and risk screen for a different individual that may be displayed by chemotherapy solutions module 108. In the illustrated example, the individual has a low risk of febrile or sever neutropenia for the given chemotherapy regimen. Thus, even though adding a G-CSF drug would reduce the individual's risk of febrile or severe neutropenia, the cost of adding the G-CSF drug is not work the benefit, given that such drugs are expensive.

From either the initial risk assessment or modify treatment plans screen, the user can select, “visualize your patient's risk score versus model population, learn more about model used to generate risk score” and chemotherapy solutions module 108 will display the individual's risk versus the model population and model details. FIG. 9E illustrates an example of such a comparison screen that may be displayed by chemotherapy solutions module 108. In FIG. 9E, the individual's risk of developing febrile or severe neutropenia versus the population is presented in graphical and text format. In addition, the source of the model used to generate the risk score is displayed.

Once the user selects the “Confirm Treatment Orders” button from the initial risk assessment or the modify treatment plan screen, chemotherapy solutions module 108 displays a confirm treatment orders screen, as illustrated in FIG. 9F. In FIG. 9F, the drugs and dosage amounts selected by the physician are displayed. The risk of febrile or sever neutropenia associated with the selected regimen is also displayed.

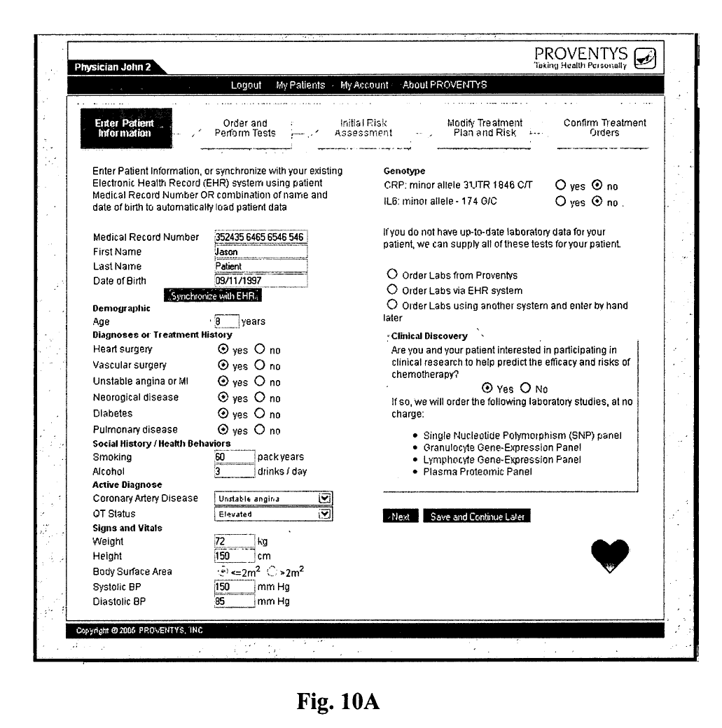

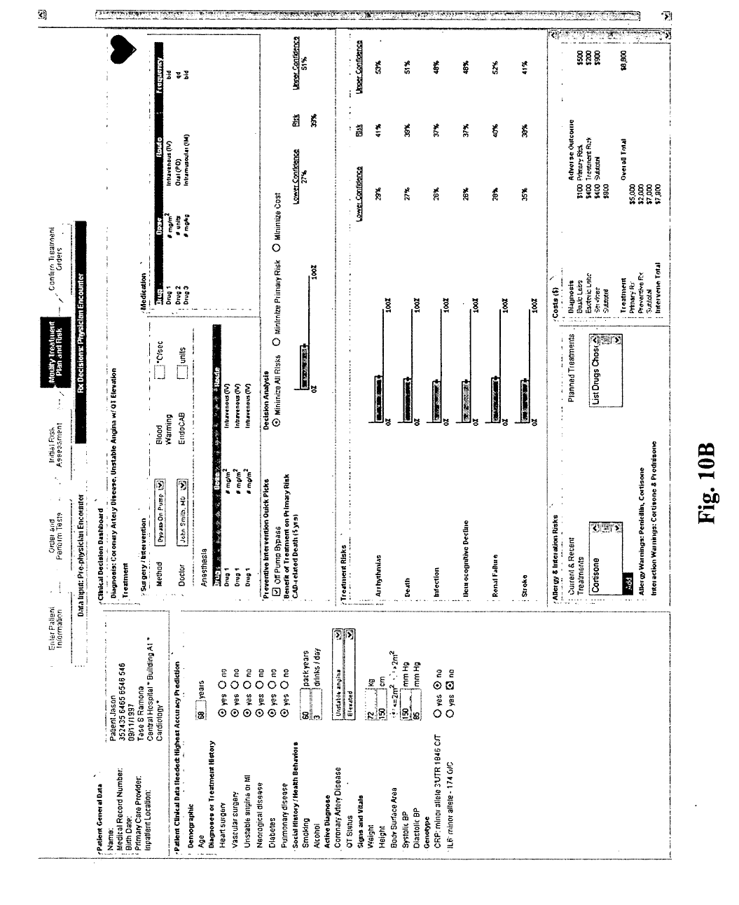

As illustrated in FIG. 1, another example of a decision support module that may be provided by system 100 is a coronary surgery solutions module 106. The purpose of coronary surgery solutions module 106 is to assist an individual in evaluating different coronary surgery options. FIG. 10A is a computer screen shot of an exemplary patient information screen that may be displayed by coronary solutions module 106 according to an embodiment of the subject matter described herein. Referring to FIG. 10A, the patient information screen includes input fields for receiving coronary-related information regarding a patient. The patient information screen also includes a button that allows the user to synchronize the information in the input fields with the patient's EHR. Once all of the information is input, the user can select “Next” to select any tests that need to be ordered. The user can then proceed to the initial risk assessment screen. These screens may display information analogous to that described above for chemotherapy solutions module 108. Hence, a description thereof will not be repeated herein.

Like chemotherapy solutions module 106, coronary surgery solutions module 108 may display risk scores associated with different treatment regimens, receive input from a user to modify treatment regimens, and automatically update risk scores based on the modified treatment regimens. FIG. 10B is a computer screen shot illustrating an exemplary modify treatment plan and risk screen that may be displayed by coronary surgery solutions module 106. Referring to FIG. 10B, the screen includes risk scores and confidence intervals associated with a plurality of different outcomes associated with coronary bypass surgery and a given set of medications for the individual. As with the chemotherapy solutions module, the user can select different treatments, and coronary surgery solutions module 106 will automatically update the risk scores for the various outcomes. Such a tool allows both physicians and patients to select optimal treatment regimens based on risk tolerance of the patients.

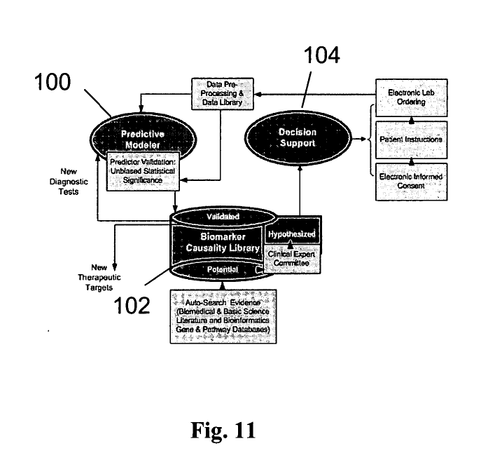

As described above, one function of the system illustrated in FIG. 1 is biomarker causality validation. FIG. 11 is a block diagram illustrating biomarker validation according to an embodiment of the subject matter described herein. Referring to FIG. 11, biomarker causality validation system 102 includes a biomarker causality library that receives potential biomarkers from automatic searching of scientific literature and databases. Biomarker causality validation system 102 also stores biomarkers whose causality has been validated by predictive modeler 100. Experts hypothesize which of the potential biomarkers should be validated. Decision support module 104 obtains consent from patients and orders tests for determining whether patients have the potential biomarkers. The potential biomarkers are provided to predictive modeler 100 after pre-processing. Predictive modeler 100 validates biomarker causality by generating models that include the new biomarkers and determining whether the biomarkers have predictive value.

Biomarker causality validation may be performed in two stages—biomarker identification and biomarker validation. Biomarker identification may include automated extraction of potential biomarkers from biological evidence (biomedical and basic science literature and bioinformatics gene and pathway disease databases) and entry into the biomarker causality library for review and clinical testing approval by clinical expert committees.

Biomarker validation may be performed on patients that use decision support module 104. Entry of approved potential biomarkers (new diagnostic test leads)in clinical care system may be enabled by tools embedded in decision support module 104 to facilitate communication and retrieval of patient consent (paper or electronic) and communication of standard and esoteric lab orders and results to and from the laboratory (electronic and/or paper). For example, the “Clinical Discovery” labs section in FIG. 10A facilitates easy ordering or all the labs at once.

Once potential biomarker data is collected, the data must be analyzed for predictive value, cost, etc. This function may be performed by predictive modeler 100. The data analysis performed by predictive modeler 100 may include construction of new models to validate the statistical significance of these potential biomarkers as predictors of the outcomes of interest, with consideration of confounding and colinearity by other factors, assessment of predictor and outcome normality for linear models, assessment of residuals normality, and assessment of outliers and bootstrapping to help exclude false positive results (validated causal biomarkers, those with both clinical and statistical significance, are moved into Validated section of biomarker causality library; can now be used in the development of new predictive models or as a stand-alone test, and can be used as targets/leads for the development of new molecular therapeutic agents. (note can also assess for effect modification by factors).

Clinical Example: Chemotherapy and Neutropenia

1) Biomarker Validation

Biomarker causality validation system 102 searches medical literature (i.e., Medline) and genome-disease association databases (i.e., OMIM—Online Mendelian Inheritance in Man) for the outcome of interest (i.e., anemia, chemotherapy), collects additional data on the potential biomarkers found from molecular information databases (i.e., Gene, Genome, SNP, etc), and stores the data in the potential biomarkers section of the biomarker causality library. The following are examples of outcomes and potential biomarkers that may be identified by biomarker causality validation system 102:

GLUCOSE-6-PHOSPHATE DEHYDROGENASE; G6PD ANEMIA, NONSPHEROCYTIC HEMOLYTIC, DUE TO G6PD DEFICIENCY, INCLUDED

Gene map locus Xq28

THROMBOTIC THROMBOCYTOPENIC PURPURA, CONGENITAL; TTP Gene map locus 9q34

BREAST CANCER 2 GENE; BRCA2 BREAST CANCER, TYPE 2, INCLUDED

Gene map locus 13q12.3

RETICULOSIS, FAMILIAL HISTIOCYTIC

NIJMEGEN BREAKAGE SYNDROME BERLIN BREAKAGE SYNDROME, NCLUDED; BBS, INCLUDED

Gene map locus 8q21

LYMPHOPROLIFERATIVE SYNDROME, X-LINKED

Gene map locus Xq25

XERODERMA PIGMENTOSUM, COMPLEMENTATION GROUP A; XPA XPA GENE

Gene map locus 9q22.3

Once the potential biomarkers have been identified, the clinical expert committee illustrated in FIG. 11 can then can view full candidate list and select the one or more biomarkers (molecular factors: genes, proteins, etc.) worth investing in testing in the validation stage (stage 2 below). For this example, it is assumed that the clinical expert committee selected G6PD mutations as a biomarker worth validating using prospective cohorts within the context of clinical care where decision support module 104 is used; the variants of the G6PD gene that might cause anemia due to chemotherapy are then moved to the hypothesized biomarker section of the biomarker causality library (this would be a genotype test of a person's G6PD alleles; in other examples, committee might require a gene-expression test, a proteomic test, etc.).

2) Biomarker Validation

a) Study Conduct: The user of biomarker causality validation system 102 obtains institutional review board approval with the institution where care/study is being conducted. A medical assistant/physician explains involvement in clinical research and details of how extra blood/tissue will be used to assess these additional biomarkers not necessary for clinical decision making currently, but which could improve decision making in the future. System 102 makes ordering of “Clinical Discovery” tests simple (box on lower right of chemotherapy solutions screen). On a third screen, system 102 then can garner informed consent approval through an electronic signature or output a PDF or paper informed consent form which the patient can review, sign and submit. Lab instructions can be printed and/or e-mailed to patient (or reviewed on their patient portal). Lab data is sent to and from the lab electronically.

b) Data Analysis (Biomarker Causality Data Analysis): Construction of new models to validate the statistical significance of these potential biomarkers as predictors of the outcomes of interest, with consideration of confounding and collinearity by other factors, assessment of predictor and outcome normality for linear models, assessment of residuals normality, and assessment of outliers and bootstrapping to help exclude false positive results (validated causal biomarkers, those with both clinical and statistical significance, are moved into the validated section of the biomarker causality library; can now be used in the development of new predictive models or as a stand-alone test, and can be used as targets/leads for the development of new molecular therapeutic agents (note can also assess for effect modification by factors).

Decision Support Example

As stated above, decision support module 104 may automatically incorporate scores from multiple models into a decision tree to enable an individual to select an optimal intervention strategy. FIG. 12 illustrates an example of such a decision tree. In FIG. 12, the decision tree includes branches that correspond to outcomes related to febrile neutropenia. The branches in FIG. 12 are only a portion of the total decision tree that relates to one approach of many approaches to using predictive modeling to evaluate treatment strategies. Other branches, such as not testing and not treating or not testing and treating the patient are not shown for simplicity. The % symbols on each branch correspond to probabilities associated with each branch. The # symbols represent quality adjusted life years. In order to assess the summary benefit and cost for each branch, the probabilities for each branch are multiplied by the total cost and total benefit. The circles in each branch mean that the values being calculated for the sub-branches should be added. A cost/benefit ratio can be calculated for each branch by dividing the total cost by the total benefit. Branches can then be compared to determine the optimal intervention strategy. The probabilities output from a predictive model used by decision support module 104 may be automatically incorporated into a decision tree, such as that illustrated in FIG. 12, to evaluate different outcomes and treatment strategies.

It will be understood that various details of the invention may be changed without departing from the scope of the invention. Furthermore, the foregoing description is for the purpose of illustration only, and not for the purpose of limitation.

What is claimed is:

1. A method for automatically generating a predictive model linking user-selected factors to a user-selected outcome, the method comprising:
(a) obtaining clinical data from a plurality of different sources for a population of individuals, the clinical data including a plurality of different physical and demographic factors regarding the individuals and a plurality of different outcomes for the individuals;
(b) receiving input regarding a search space including models linking different combinations of the factors and at least one of the outcomes; and
(c) in response to receiving the input:
(i) performing a search for models in the search space based on predictive value of the models with regard to the outcome; and
(ii) processing the models identified in step (c)(i) to produce a final model linking one of the combinations of factors to the outcome, wherein the final model indicates a likelihood that an individual having the factors in the final model will have the outcome.

2. The method of claim 1 wherein obtaining clinical data from a plurality of sources includes obtaining at least two of: past medical history, social and lifestyle data, physical examination information, self-reported demographic information, demographic data established through environmental Global Information Systems databases, genotype and SNP information, gene-expression information, proteomic information including at least one of antibody or cytokine data, metabolomic information, mass spectroscopy information, imaging coordinates from x-ray, mammography, computerized axial tomography (CAT), magnetic resonance imaging (MRI), electrocardiogram (EKG) information, magnetoencephalography (MEG), electroencephalography (EEG) and functional magnetic resonance imaging (fMRI) information.

3. The method of claim 1 wherein receiving input includes receiving input from a user.

4. The method of claim 1 wherein receiving input includes receiving via a direct link to computer software where users enter factor data.

5. The method of claim 1 comprising preprocessing the clinical data from the different sources before performing the search.

6. The method of claim 5 wherein preprocessing the clinical data includes normalizing the clinical data.

7. The method of claim 5 wherein preprocessing the clinical data includes removing non-varying values from the clinical data.

8. The method of claim 5 wherein preprocessing the clinical data includes reducing the number of factors in the clinical data.

9. The method of claim 8 wherein reducing the number of factors in the clinical data includes using k-means clustering to identify clusters of values for a factor and singular value decomposition to select a principal component of each cluster, the principal component having a value representative of the cluster.

10. The method of claim 1 wherein performing a search of the models includes using factor-limited enumeration of all possible models.

11. The method of claim 1 wherein performing a search of the models includes using a stepwise search method.

12. The method of claim 1 wherein performing a search of the models includes using a stochastic search method.

13. The method of claim 1 wherein performing a search of the models includes selecting and assigning a score to each of the models using Akaike information criteria.

14. The method of claim 1 wherein performing a search of the models includes selecting and assigning a score to the models using Bayesian information criteria.

15. The method of claim 1 wherein processing the models includes evaluating the predictive accuracy of models using a receiver operating curve (ROC).

16. The method of claim 15 wherein evaluating the predictive accuracy using a receiver operating curve includes evaluating the predictive accuracy using the area under the curve, a concordance index, and a sensitivity and specificity of each model.

17. The method of claim 1 wherein the outcome includes a surgical outcome.

18. The method of claim 1 wherein the outcome includes a disease outcome.

19. The method of claim 1 wherein the outcome includes a timing associated with the outcome.

20. The method of claim 1 wherein the outcome includes an individual's response to a therapeutic treatment.

21. The method of claim 1 wherein the outcome includes a clinical trial outcome.

22. The method of claim 1 wherein the outcome includes a healthcare-related business outcome.

23. The method of claim 1 comprising evaluating and revising the final model using at least one dataset that is outside of the data obtained for the population of individuals to reduce over-fitting of the final model to the population of individuals.

24. The method of claim 1 comprising comparing and rating the final model with respect to other models located in the search based on criteria other than predictive value.

25. The method of claim 24 wherein the criteria other than predictive value includes specific information about factors.

26. The method of claim 25 wherein the specific information about factors includes cost associated with obtaining a particular type of clinical data used in each of the models.

27. The method of claim 25 wherein the specific information about factors includes risk associated with obtaining a particular type of clinical data used in each of the models.

28. The method of claim 25 wherein the specific information about factors includes risk associated with a patient undergoing a diagnostic associated with a model.

29. The method of claim 1 comprising producing a decision tree based on the final model to separate groups of patients by differences in the patients with regard to individual factors in the final model.

30. The method of claim 1 comprising automatically updating the final model in response to receipt of new clinical data for a new pool of individuals.

31. The method of claim 30 comprising creating a tailored predictive model for the new pool of individuals in response to receipt of the new clinical data.

32. The method of claim 31 wherein creating a tailored predictive model for the new pool of individuals includes creating the predictive model using the new clinical data.

33. The method of claim 1 wherein steps (a)-(c) are implemented as a computer program product comprising computer-executable instructions embodied in a computer-readable medium.

34. The method of claim 1 comprising automatically incorporating scores from a plurality of predictive models into a decision tree for selecting an optimal intervention for treating the outcome.

35. The method of claim 1 comprising using the final model as a decision support tool for a patient.

36. The method of claim 34 wherein using the final model as a decision support tool includes outputting a set of outcomes for the patient.

37. The method of claim 35 wherein outputting a set of outcomes for the patient includes listing outcomes and therapeutic recommendations analyzed for the patient in the past, new outcomes and recommendations, and outcomes not yet analyzed.

38. The method of claim 36 wherein outputting a set of outcomes includes organizing the outcomes by disease and therapeutic category.

39. The method of claim 1 comprising using the final model to generate statistics on risk of an aggregate subpopulation of people versus risk of the complete population for the outcome.

40. A method for generating a hierarchy of models for predicting a medical outcome, the method comprising:
(a) obtaining clinical data for a population of individuals;
(b) identifying factors associated with the population that are indicative of a medical outcome;
(c) generating, based on the factors, a plurality of predictive models for predicting the medical outcome; and
(d) arranging the models in a hierarchical manner based on relative predictive value and at least one additional metric associated with applying each model to an individual.

41. The method of claim 40 wherein the at least one additional metric comprises cost of performing a test to determine whether an individual has a particular factor.

42. The method of claim 40 wherein the at least one additional metric includes risk of performing a test to determine whether an individual has a particular factor.

43. A system for automatically generating a predictive model linking user-selected factors to a user-selected outcome, the system comprising:
(a) a data collection module for obtaining clinical data from a plurality of different sources for a population of individuals, the clinical data including a plurality of different physical and demographic factors regarding the individuals and a plurality of different outcomes for the individuals;
(b) a user interface module for receiving input regarding a search space including models linking different combinations of the factors and at least one of the outcomes; and
(c) a predictive modeler for, in response to receiving the input:
(i) performing a search for models in the search space based on predictive value of the models with regard to the outcome; and
(ii) processing the models identified in the search to produce a final model linking at least one of the combinations of factors identified in the search to the selected outcome.

44. The system of claim 43 wherein the outcome comprises an individual medical outcome.

45. The system of claim 43 wherein the outcome comprises a healthcare-related business outcome.

46. A system for evaluating an individual's risk of a clinical outcome, the system comprising:
(a) a predictive modeler for obtaining clinical data regarding a population of individuals and for generating models linking factors associated with the population to clinical outcomes; and
(b) a decision support module for receiving input regarding factors possessed by an individual, for receiving input regarding a treatment regimen for the individual, for applying at least one of the models generated by the predictive modeler to the input, and for outputting results indicating the individual's risk of having one of the clinical outcomes given the selected treatment regimen.

47. The system of claim 44 comprising a biomarker causality identification module for identifying new factors to be used by the predictive modeler, wherein the biomarker causality identification module is adapted to query medical literature to identify biomarkers to be used by the predictive model in generating the models.

48. The system of claim 46 wherein the decision support module comprises a coronary surgery solutions module for outputting risk scores associated with a plurality of different outcomes associated with performing coronary surgery.

49. The system of claim 46 wherein the decision support module comprises a chemotherapy solutions module for outputting a risk score indicating the individual's risk of an adverse reaction to a chemotherapy regimen.

50. The system of claim 46 wherein the decision support module is adapted to receive input regarding a particular treatment and to reevaluate the probability of the outcome in response to the particular treatment.

51. A computer program product comprising computer-executable instructions embodied in a computer readable medium for performing steps comprising:
(a) presenting a user with a screen for collecting clinical information regarding an individual to be subjected to a treatment regimen;
(b) receiving the clinical information from the user;
(c) applying a predictive model and presenting the user with a decision support screen displaying the treatment regimen and a risk score associated with a clinical outcome associated with the treatment regimen; and
(d) receiving input from the user for modifying the treatment regimen, and automatically updating and displaying the risk score associated with the clinical outcome.
